(19) United States
(12) Patent Application Publication
(10) Pub. No.: US 2017/0099081 A1
(43) Pub. Date: Apr. 6, 2017

(54) INFORMATION PROCESSING DEVICE AND CONTROL METHOD THEREFOR

(71) Applicant: NEC Corporation, Tokyo (JP)

(72) Inventors: Kenichiro FUJII, Tokyo (JP); Michio NAGAI, Tokyo (JP); Tatsuyuki SHINTANI, Tokyo (JP)

(21) Appl. No.: 15/126,964

(22) PCT Filed: Jan. 13, 2015
(86) PCT No.: PCT/JP2015/050611

§ 371 Date: Sep. 16, 2016

(30) Foreign Application Priority Data
Mar. 18, 2014 (JP) 2014-054545

(51) Int. Cl. H04B 5/00; H04W 76/02; H04W 4/02

(52) U.S. Cl. CPC H04B 5/0031; H04W 4/023; H04W 76/02

(57) ABSTRACT

This information processing device (100) has: communication unit (110) that performs near-field wireless communication with other information processing devices; determination unit (120) that determines whether another information processing device (100) has come into proximity on the basis of the communication result of the communication unit (110); and control unit (130) that, if the determination result of the determination unit (120) indicates that another information processing device (100) has come into proximity, causes the communication unit (110) to transition to a reception mode and, if the determination result from the determination unit (120) indicates that another information processing device (100) has not come into proximity, causes the communication unit (110) to transition to a transmission mode.

### TECHNICAL FIELD

The present invention relates to an information processing device and a control method therefor.

### BACKGROUND ART

Recent years have seen the development of more compact and lighter weight information processing devices such as notebook PCs (Personal Computers) and tablet terminals. With the development of more compact and lighter weight information processing devices, a form of use has become common in which each participant in a conference views conference materials on his or her own information processing device. This form of use necessitates the distribution of data such as conference materials to each participant.

One method of distributing data involves the use of electronic mail. In this method, the distributor of data must obtain the e-mail addresses of the participants. However, there are cases in which the participants are not identified in advance, and in such cases, the method of using e-mail does not allow the distribution of data to participants.

Patent Document 1 (Japanese Unexamined Patent Application Publication No. 2002-204239) discloses a technology for the transmission and reception of data between a first information processing device that is equipped with an RF (Radio Frequency) tag and a second information processing device that is equipped with a reader/writer that is capable of communication with an RF tag. According to this technology, near-field communication is implemented by placing the first information processing device in proximity to the second information processing device, whereby data are transmitted from the second information processing device to the first information processing device.

### LITERATURE OF THE PRIOR ART

### Patent Documents

Patent Document 1: Japanese Unexamined Patent Application Publication No. 2002-204239

### SUMMARY OF THE INVENTION

### Problem to be Solved by the Invention

In the technology disclosed in Patent Document 1, the communication between the first information processing device and the second information processing device is in a one-to-one relation. Thus, to cause a plurality of first information processing devices to receive data, the first information processing devices must be placed one by one in proximity to the second information processing device, resulting in the problem of the expenditure of time and trouble. It is an object of the present invention to provide an information processing device and a control method for the information processing device that enable the distribution of data to a plurality of information processing devices by a simple method.

### Means for Solving the Problem

The information processing device of the present invention for achieving the above-described object is provided with:
a communication unit that carries out near-field wireless communication with other information processing devices;
a determination unit that, on the basis of the results of communication of the communication unit, determines whether another information processing device is in proximity; and
a control unit that, on the basis of the determination result of the determination unit, controls the communication operation of the communication unit;
wherein:
the control unit causes the communication unit to transition to a reception mode when the result of determination of the determination unit indicates that another information processing device has come into proximity, and causes the communication unit to transition to a transmission mode when the result of determination of the determination unit indicates that another information processing device has not come into proximity.

The control method of an information processing device of the present invention for achieving the above-described object is a control method of an information processing device, wherein:
the information processing device is provided with a communication unit that carries out near-field wireless communication with other information processing devices,
whether another information processing device has come into proximity is determined on the basis of the result of communication of the communication unit; and
when the determination result indicates that another information processing device has come into proximity, the communication unit is caused to transition to a reception mode and the communication unit is caused to transition to a transmission mode when the result of the determination indicates that another information processing device has not come into proximity.

### Effect of the Invention

According to the present invention, data can be distributed to a plurality of information processing devices by a simple method.

### BRIEF DESCRIPTION OF THE DRAWINGS

FIG. 1 is a block diagram showing the principal configuration of an information processing device of the first exemplary embodiment of the present invention.

FIG. 2 is a block diagram showing the principal configuration of an information processing device of the second exemplary embodiment of the present invention.

FIG. 3 is a frontal view showing the outer appearance of the information processing device shown in FIG. 2.

FIG. 4 is a sectional view taken along line A-A′ shown in FIG. 3.

FIG. 5 is a view describing an outline of the operation of the information processing device shown in FIG. 2.

FIG. 6 is a view describing an outline of the operation of the information processing device shown in FIG. 2.

FIG. 7 is a flow chart showing the operation of the information processing device shown in FIG. 2.

FIG. 8 shows the state in which a plurality of the information processing devices shown in FIG. 2 are stacked together.

FIG. 9 is a flow chart showing the operation in the information processing devices shown in FIG. 2 at the time of determining the positional relation with other information processing devices that are in proximity.

FIG. 10 is a view describing an outline of another operation of the information processing device shown in FIG. 2.

FIG. 11 is a frontal view of the information processing device shown in FIG. 2.

FIG. 12 is a sectional view taken along line B-B′ shown in FIG. 11.

FIG. 13 is a sectional view taken along line C-C′ shown in FIG. 11.

FIG. 14 shows an example of an image that is displayed on the display unit shown in FIG. 2.

FIG. 15 is a view describing another operation of the information processing devices shown in FIG. 2.

FIG. 16 is a view describing another operation of the information processing devices shown in FIG. 2.

### BEST MODE FOR CARRYING OUT THE INVENTION

Exemplary embodiments of the present invention are next described with reference to the accompanying drawings.

### First Exemplary Embodiment

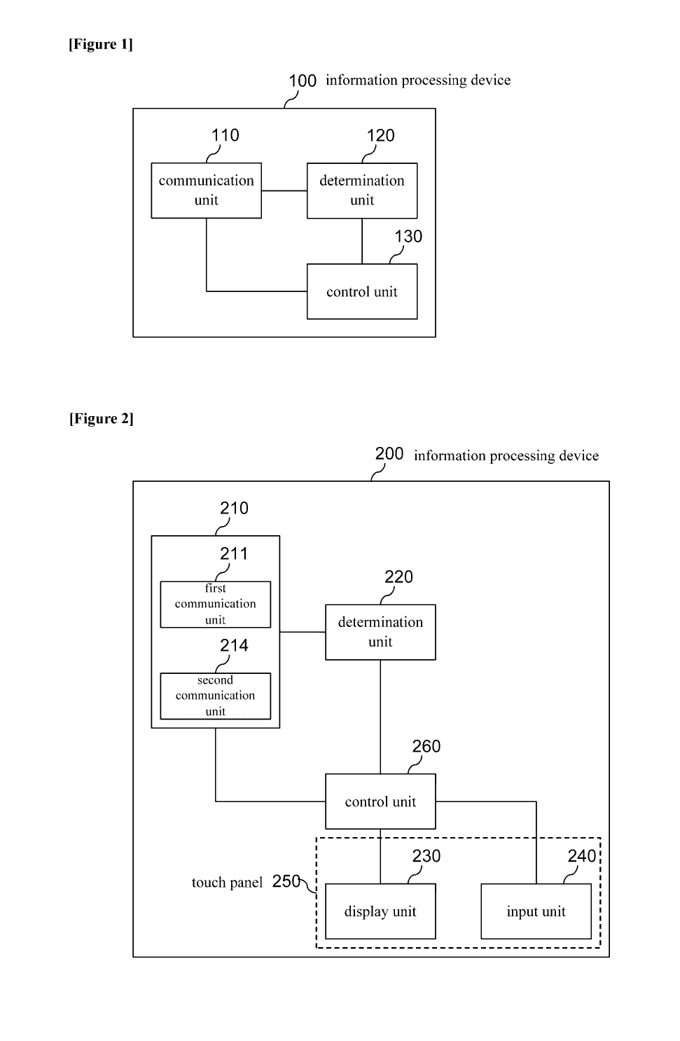

FIG. 1 is a block diagram showing the principal configuration of information processing device 100 of the first exemplary embodiment of the present invention.

Information processing device 100 shown in FIG. 1 has communication unit 110, determination unit 120, and control unit 130.

Communication unit 110 performs near-field wireless communication with other information processing devices 100 in accordance with, for example, NFC (Near Field Communication) standards.

Determination unit 120 determines, on the basis of the result of communication of communication unit 110, whether another information processing device 100 is in proximity.

Control unit 130 controls the communication operation of communication unit 110 on the basis of the determination result of determination unit 120.

The operation of information processing device 100 is next described.

Control unit 130 causes communication unit 110 to transition to a reception mode when the determination result of determination unit 120 indicates that another information processing device 100 has come into proximity. On the other hand, control unit 130 causes communication unit 110 to transition to a transmission mode when the determination result of determination unit 120 indicates that another information processing device 100 has not come into proximity.

In this way, information processing device 100 of the present exemplary embodiment has: communication unit 110 that performs near-field wireless communication with other information processing devices 100, determination unit 120 that, on the basis of the result of communication of communication unit 110, determines whether another information processing device 100 has come into proximity, and control unit 130 that controls the communication operation of communication unit 110.

Control unit 130 causes communication unit 110 to transition to the reception mode when the determination result of determination unit 120 indicates that another information processing device has come into proximity. Control unit 130 further causes communication unit 110 to transition to the transmission mode when the determination result of determination unit 120 indicates that another information processing device 100 has not come into proximity.

As a result, by placing a plurality of information processing devices 100 in proximity, communication units 110 of this plurality of information processing devices 100 can be caused to transition to the reception mode. Then, by causing information processing device 100 that is not in proximity with the other information processing devices 100 and in which communication unit 110 has transitioned to the transmission mode to newly come into proximity with this plurality of information processing devices 100, data can be transmitted all at once from information processing device 100 that has newly come into proximity to the plurality of information processing devices 100.

Accordingly, communication units 110 of a plurality of information processing devices 100 can be caused to transition to the reception mode by, for example, stacking together a plurality of information processing devices 100. Data can then be transmitted (distributed) all at once to this plurality of information processing devices 100 by the simple method of causing information processing devices 100 in which communication unit 110 has transitioned to the transmission mode to come into proximity.

### Second Exemplary Embodiment

FIG. 2 is a block diagram showing the principal configuration of information processing device 200 of the second exemplary embodiment of the present invention.

Information processing device 200 shown in FIG. 2 has: communication unit 210, determination unit 220, display unit 230, input unit 240, and control unit 260.

Communication unit 210 has first communication unit 211 and second communication unit 214. First communication unit 211 performs near-field wireless communication with another information processing device 200 in accordance with, for example, the NFC standard.

Second communication unit 214 performs communication with another information processing device 200 in accordance with wireless an LAN (Local Area Network) standard such as Wi-Fi (Wireless Fidelity) (registered trademark). The communication method of second communication unit 214 is not limited to this form, and the communication speed of second communication unit 214 is assumed to be faster than the communication speed of first communication unit 211.

On the basis of the result of communication of first communication unit 211, determination unit 220 determines whether another information processing device 200 has come into proximity. More specifically, when first communication unit 211 is able to transmit and receive signals with another information processing device 200, determination unit 220 determines that another information processing device 200 has come into proximity. On the other hand, when first communication unit 211 is not able to transmit or receive signals with another information processing device 200, determination unit 220 determines that another information processing device 200 has not come into proximity

Display unit 230 displays various pictures according to the control of control unit 260.

Input unit 240 detects operation input from the user and supplies signals that accord with the operation content that was received as input to control unit 260. One specific example of input unit 240 is a touch pad that detects the contact or proximity of an object such as a finger or stylus pen and that supplies a signal that accords with the position of the contact or proximity of the object. In this case, input unit 240 that is a touch pad is arranged superimposed on display unit 230 and, together with display unit 230, constitutes what is referred to as a touch panel. In the following explanation, display unit 230 and input unit 240 are assumed to constitute touch panel 250.

Control unit 260 controls each part on the basis of signals from input unit 240. For example, control unit 260 controls the communication operation of communication unit 210 on the basis of the determination result of determination unit 220. More specifically, when performing transmission or reception of data, control unit 260 causes first communication unit 211 to carry out near-field wireless communication and then causes communication unit 210 to transition to the reception mode or transmission mode based on the determination result of determination unit 220 that indicates whether another information processing device 200 has come into proximity.

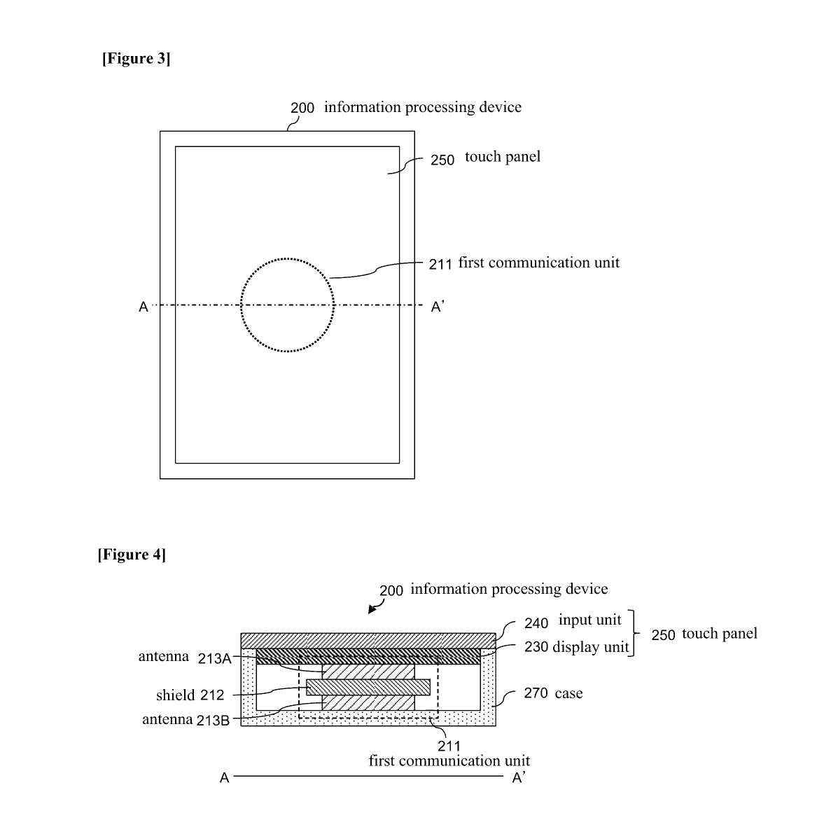

FIG. 3 is a frontal view showing the outer appearance of information processing device 200.

As shown in FIG. 3, touch panel 250 is arranged to cover substantially the entire surface of one surface (front surface) of information processing device 200. Further, first communication unit 211 is arranged along the front surface of information processing device 200 in substantially the center of information processing device 200. First communication unit 211 is normally arranged inside the case of information processing device 200 and is therefore not outwardly visible. However, for the sake of convenience in this explanation, first communication unit 211 is indicated by dotted lines in FIG. 3.

FIG. 4 is a sectional view taken along line A-A′ shown in FIG. 3. As shown in FIG. 4, display unit 230 is arranged below input unit 240, which is a touch pad. Display unit 230 and input unit 240 make up touch panel 250. As shown in FIG. 4, first communication unit 211 has shield 212 and two antennas 213A and 213B.

Shield 212 is provided along display unit 230. Gaps are provided between shield 212 and display unit 230 and between shield 212 and case 270 of the rear-surface side of information processing device 200.

Antenna 213A is provided on the surface of shield 212 on the side of display unit 230, i.e., on the front-surface side of information processing device 200.

Antenna 213B is provided on the surface of shield 212 of the side opposite the surface on which antenna 213a is provided, i.e., on the rear-surface side of information processing device 200. Determination unit 220 determines whether another information processing device 200 has come into proximity on the basis of the states of signal reception of antennas 213A and 213B. As described hereinabove, shield 212 is provided between antenna 213A and antenna 213B. As a result, a signal that arrives from the front-surface side of information processing device 200 is received by antenna 213A, but is not received by antenna 213B due to screening by shield 212. On the other hand, a signal that arrives from the rear-surface side of information processing device 200 is received by antenna 213B but is not received by antenna 213A due to screening by shield 212.

As a result, when another information processing device 200 comes into proximity, determination unit 220 is also able to determine the positional relation between its own device and the other information processing device 200 (whether the other information processing device 200 is positioned on the front-surface side or positioned on the rear-surface side) on the basis of the states of signal reception of antennas 213A and 213B.

The method of using information processing device 200 to transmit and receive data is next described.

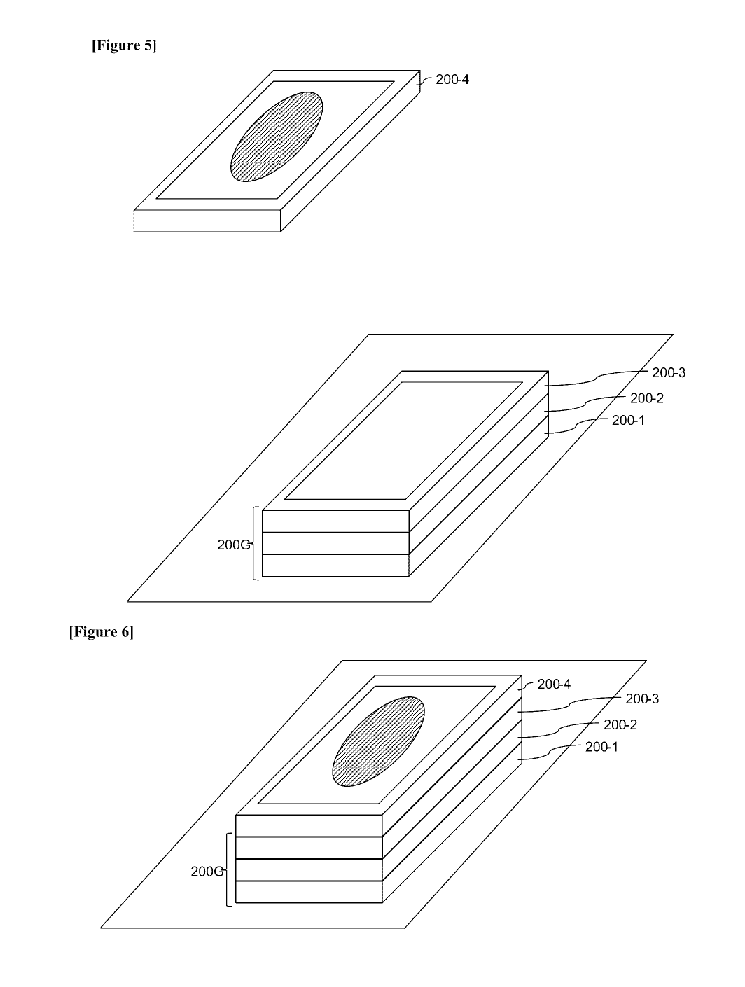

In the following explanation, an example is described in which data stored in information processing device 200-4 are to be received in three information processing devices 200-1,200-2, and 200-3, as shown in FIG. 5.

When carrying out data transmission/reception, information processing devices 200-1-200-4 each cause first communication unit 211 to start communication (transmission/reception of signals). Information processing devices 200-1-200-3 that are on the data reception side are then stacked together on, for example, a desk as shown in FIG. 5. In FIG. 5, information processing device 200-1 is placed on the desk, information processing device 200-2 is placed on information processing device 200-1, and information processing device 200-3 is placed on information processing device 200-2.

In the state shown in FIG. 5, each of information processing devices 200-1-200-3 carries out near-field wireless communication and determines whether other information processing devices 200 are in proximity.

As described hereinabove, information processing devices 200-1-200-3 are stacked together and in proximity, whereby each of information processing devices 200-1-200-3 determines that other information processing devices are in proximity (determines that its own device belongs to information processing device group 200G that is made up from a plurality of information processing devices 200 that are in proximity).

Upon determining that other information processing devices 200 are in proximity, each of information processing devices 200-1-200-3 causes communication unit 210 to transition to the reception mode. In addition, each of information processing devices 200-1-200-3 uses near-field wireless communication to transmit and receive identification information with each other to identify its own device. Each of information processing devices 200-1-200-3 is thus able to identify each of the information processing devices that belong to information processing device group 200G. In addition, the identification information of an information processing device is information such as the communication ID (identifier) that is necessary for an information processing device to use second communication unit 214 to carry out communication.

In addition, each of information processing devices 200-1-200-3 determines whether its own device is, from among the information processing devices that belong to information processing device group 200G, the master device that is arranged at a predetermined position. As described hereinabove, when in proximity to other information processing devices 200, information processing device 200 is able to determine its positional relation with the other information processing devices 200 on the basis of the states of signal reception of antennas 213A and 213B. As a result, each of information processing devices 200-1-200-3 is able to determine whether its own device is the master device. In the following description, the master device is assumed to be information processing device 200 that, from among the plurality of information processing devices 200 that are stacked together, is arranged uppermost.

As shown in FIG. 5, information processing device 200-3 is arranged uppermost. As a result, information processing device 200-3 determines that its own device is the master device. Information processing device 200-3 determines that its own device is the master device, and upon causing communication unit 210 to transition to the reception mode, determines whether another information processing device 200 other than information processing devices that belong to information processing device group 200G has come into proximity.

On the other hand, when carrying out transmission and reception of data, information processing device 200-4 that is on the data transmission side is maintained in a separated state from the other information processing devices 200-1-200-3.

In the state shown in FIG. 5, information processing device 200-4 determines whether another information processing device 200 has come into proximity. Information processing device 200-4 is separated from other information processing devices 200-1-200-3 and therefore is unable to use near-field wireless communication to transmit and receive signals with other information processing devices 200. Information processing device 200-4 determines that other information processing devices 200 are not in proximity when the state in which near-field wireless communication cannot be used to transmit or receive signals with other information processing devices 200 for more than a predetermined time interval.

Information processing device 200-4 causes communication unit 210 to transition to the transmission mode upon determining that another information processing device 200 has not come into proximity. Information processing device 200-4 then receives the designation of data that are to be transmitted and displays the designated data on display unit 230. Information processing device 200-4 then determines whether another information processing device 200 has newly come into proximity

After information processing device 200-4 causes communication unit 210 to transition to the transmission mode and information processing devices 200-1-200-3 have caused communication units 210 to transition to reception mode, information processing device 200-4 is stacked upon information processing device group 200G (information processing device 200-3) as shown in FIG. 6.

When information processing device 200-4 has been stacked upon information processing device 200-3, information processing device 200-3 determines that information processing device 200-4 has newly come into proximity. Upon determining that information processing device 200-4 has newly come into its proximity, information processing device 200-3 uses near-field wireless communication to transmit the communication ID of each information processing device that belongs to information processing device group 200-G to information processing device 200-4. In addition, information processing device 200-3 carries out near-field wireless communication with other information processing devices 200 that belong to information processing device group 200G and reports that information processing device 200-4 has newly come into proximity.

When information processing device 200-4 newly comes into proximity with information processing device group 200G after the transition to the reception mode, each of information processing devices 200-1-200-3 uses second communication units 214 to receive data transmitted from information processing device 200-4.

On the other hand, when information processing device 200-4 is stacked on information processing device 200-3, information processing device 200-4 determines that information processing device 200-3 has newly come into proximity. Upon determining that information processing device 200-3 has newly come into proximity, information processing device 200-4 uses near-field wireless communication to receive from information processing device 200-3 the communication ID of each information processing device that belongs to information processing device group 200G. Information processing device 200-4 then uses second communication unit 214 to transmit the designated data to information processing devices 200 indicated by the received communication IDs.

First communication unit 211 can also be used to transmit and receive data. However, the communication speed of near-field wireless communication based on, for example, the NFC standard is not particularly fast, and transmission may be time-consuming depending on the amount of data to be transmitted. As described hereinabove, the communication speed of second communication unit 214 is faster than the communication speed of first communication unit 211, and the time spent for transmission can be reduced by using second communication unit 214 to transmit and receive data.

Thus, in a data transmission/reception method that uses information processing device 200, a plurality of information processing devices 200 are brought into proximity and then another information processing device 200 is newly brought into proximity. By means of this approach, a plurality of information processing devices 200 that belong to information processing device group 200G can be caused to receive data all at once from information processing device 200 that is newly brought into proximity. Accordingly, a plurality of information processing devices 200 can be caused to receive data by the simple method of, for example, stacking together a plurality of information processing devices 200 and then newly bringing information processing device 200 that stores data that are to be distributed into proximity with this plurality of information processing devices 200.

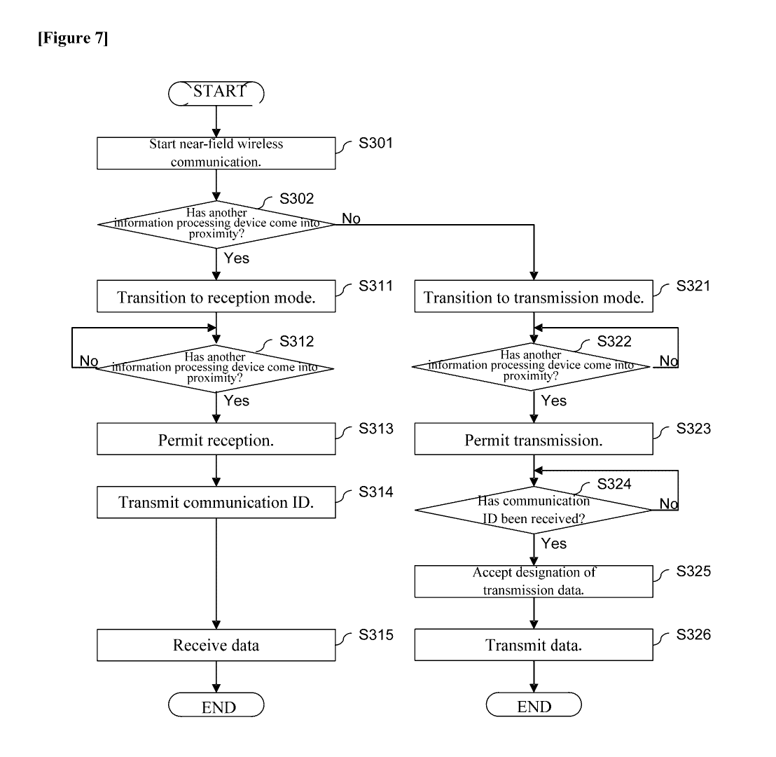

The operation of information processing device 200 is next described in detail with reference to the flow chart shown in FIG. 7.

Upon receiving input indicating that data transmission/reception is to be carried out, control unit 260 causes first communication unit 211 to start near-field wireless communication (Step S301). When first communication unit 211 starts near-field wireless communication, determination unit 220 determines whether other information processing devices 200 are in proximity on the basis of the result of the communication of first communication unit 211 (Step S302) and reports the determination result to control unit 260. In addition, upon determining that another information processing device 200 is in proximity, determination unit 220 determines the positional relation between this information processing device 200 and its own device on the basis of the state of reception of signals of antennas 213A and 213B and reports this determination result to control unit 260. The details of the method of determining the positional relation will be described later.

Upon being notified from determination unit 220 that another information processing device 200 is in proximity (YES in Step S302), control unit 260 causes communication unit 210 to transition to the reception mode (Step S311).

In addition, control unit 260 determines whether its own device is the master device on the basis of the positional relation between its own device and the other information processing devices 200 that are in proximity that were reported from determination unit 220. In the following explanation, control unit 260 is assumed to determine that its own device is the master device. Upon determining that its own device is the master device, control unit 260 causes first communication unit 211 to carry out near-field wireless communication with the other information processing devices and acquires the communication ID of each information processing device that belongs to the information processing device group.

After communication unit 210 has transitioned to the reception mode and it has been determined that its own device is the master device, determination unit 220 determines whether information processing device 200 has newly come into proximity (Step S312).

If it is determined that information processing device 200 has not newly come into proximity (NO in Step S312), determination unit 220 repeats the process of Step 5312.

If it is determined that information processing device 200 has newly come into proximity (YES in Step S312), determination unit 220 reports this determination to control unit 260.

Upon being notified from determination unit 220 that information processing device 200 has newly come into proximity, control unit 260 permits the reception of data using second communication unit 214 (Step S313). In addition, control unit 260 causes first communication unit 211 to report to other information processing devices 200 that belong to the information processing device group that information processing device 200 has newly come into proximity. When control unit 260 determines that its own device is not the master device, in place of the process of Step 5312, control unit 260, upon being notified from another information processing device 200 that information processing device 200 has newly come into proximity, proceeds to the process of Step 5313.

Control unit 260 next causes first communication unit 211 to transmit the communication ID of each information processing device belonging to the information processing device group to information processing device 200 that was determined to have come into proximity in Step S312 (Step S314).

Control unit 260 next causes second communication unit 214 to receive data that are transmitted from information processing device 200 that was determined to have newly come into proximity in Step S312 (Step S315). If control unit 260 has determined that its own device is not the master device, control unit 260 proceeds to the process of Step S315 without carrying out the process of Step S314.

On the other hand, if notified from determination unit 220 that another information processing device 200 has not come into proximity (NO in Step S302), control unit 260 causes communication unit 210 to transition to the transmission mode (Step S321). After communication unit 210 has transitioned to the transmission mode, determination unit 220 determines whether another information processing device 200 has newly come into proximity (Step S322).

If determination unit 220 determines that another information processing device 200 has not come into proximity (NO in Step S322), determination unit 220 repeats the process of Step 5322. If determination unit 220 determines that another information processing device 200 has come into proximity (YES in Step S322), determination unit 220 reports this determination to control unit 260.

Upon being notified from determination unit 220 that another information processing device 200 has newly come into proximity, control unit 260 permits the transmission of data using second communication unit 214 (Step S323).

Control unit 260 next determines whether the communication ID of each information processing device belonging to the information processing device group has been received from the master device of the information processing device group by way of first communication unit 211 (Step S324).

If control unit 260 determines that the communication ID of each information processing device belonging to the information processing device group has not been received (NO in Step S324), control unit 260 repeats the process of Step 5324.

If control unit 260 determines that the communication ID of each information processing device belonging to the information processing device group has been received (YES in Step S324), control unit 260 receives designation of the transmission data by way of input unit 240 (Step S325).

When the transmission data have been designated, control unit 260 causes second communication unit 214 to transmit the designated data to each information processing device 200 indicated by the received communication IDs (Step S326).

Details of the method of determining the position of information processing device 200 that has come into proximity are next described.

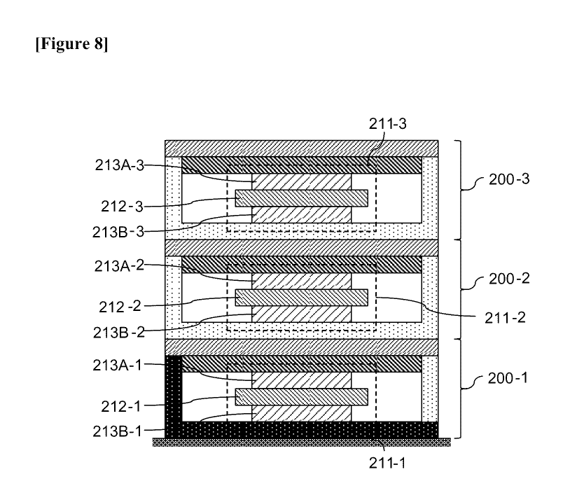

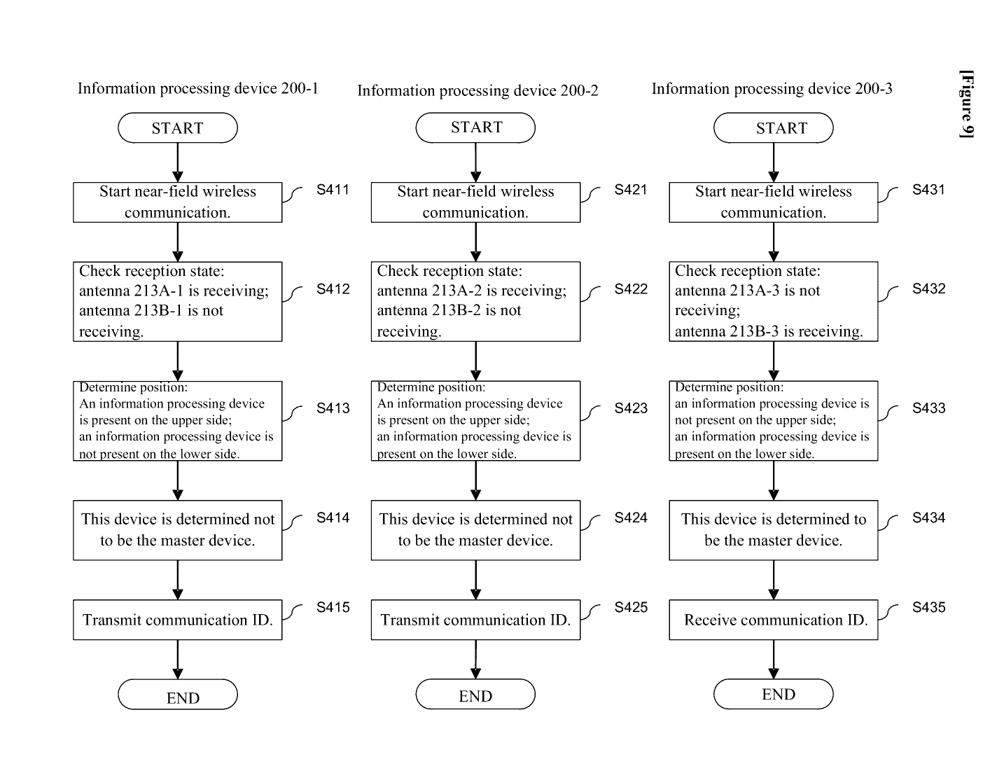

In the following explanation, it will be assumed that information processing device 200-1 is placed on, for example, a desk, information processing device 200-2 is stacked upon information processing device 200-1, and information processing device 200-3 is stacked upon information processing device 200-2, as shown in FIG. 8.

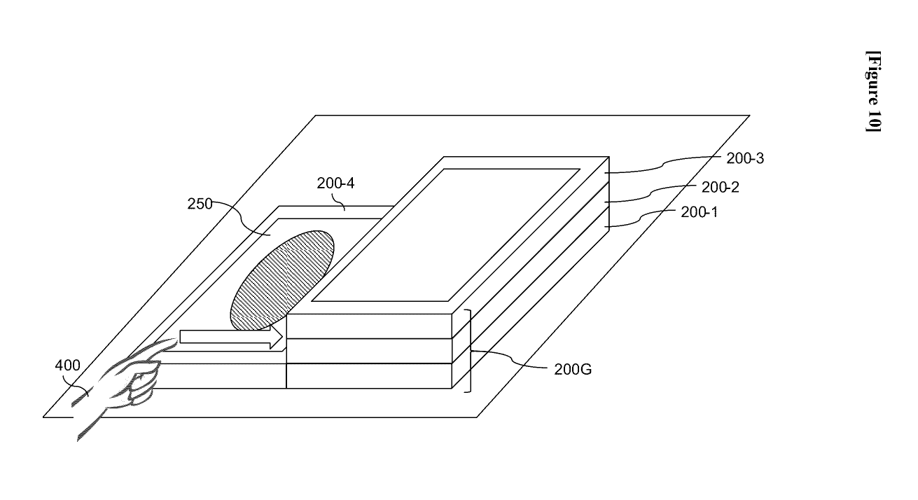

FIG. 9 is a flow chart showing the operation of information processing devices 200-1, 200-2, and 200-3 shown in FIG. 8. In the following explanation, of the information processing devices belonging to the information processing device group, information processing device 200 that is arranged uppermost is assumed to be the master device.

In the following explanation, it is assumed that, for example, an acceleration senor is provided in each information processing device 200. In this case, determination unit 220 is able to distinguish the orientation of information processing device 200 (which of the front-surface side and rear-surface side of information processing device 200 is oriented upward) on the basis of the detection result of the acceleration sensor.

Upon receiving input indicating the transmission/reception of data, control unit 260 (control unit 260-1) of information processing device 200-1 causes first communication unit 211 (first communication unit 211-1) to start near-field wireless communication (signal transmission/reception) (Step S411).

Determination unit 220 (determination unit 220-1) of information processing device 200-1 next checks the state of signal reception of first communication unit 211-1. More specifically, determination unit 220-1 checks the state of signal reception of each of antennas 213A and 213B (antennas 213A-1 and 213B-1) of first communication unit 211-1 (Step S412).

As shown in FIG. 8, information processing device 200-1 is arranged such that its rear-surface side contacts the desk. As a result, antenna 213B-1 that is provided on the rear-surface side does not receive signals from other information processing devices 200. On the other hand, information processing device 200-2 is arranged stacked upon the front-surface side of information processing device 200-1. As a result, antenna 213A-1 that is provided on the front-surface side receives a signal from information processing device 200-2.

Determination unit 220-1 next determines the position of information processing device 200-1 on the basis of the states of signal reception of each of antennas 213A and 213B (Step S413). More specifically, because antenna 213A-1 receives a signal but antenna 213B-1 does not receive a signal, determination unit 220-1 determines that another information processing device 200 is in proximity to the front-surface side of information processing device 200 but that another information processing device 200 is not in proximity to the rear-surface side.

As shown in FIG. 8, information processing device 200-1 is arranged such that the front-surface side is oriented upward. As a result, determination unit 220-1 determines that another information processing device 200 is in proximity on the upper side of information processing device 200-1 and that another information processing device 200 is not in proximity on the lower side. Determination unit 220-1 then reports the determination result to control unit 260-1.

Upon being notified that another information processing device 200 is in proximity on the upper-surface side of information processing device 200-1 but that another information processing device 200 is not in proximity on the lower-surface side, control unit 260-1 determines that information processing device 200-1 is not arranged uppermost among information processing devices belonging to the information processing device group. As a result, control unit 260-1 determines that information processing device 200-1 is not the master device (Step S414).

Upon determining that information processing device 200-1 is not the master device, control unit 260-1 causes first communication unit 211-1 to transmit the communication ID of information processing device 200-1 to the master device (Step S415).

Upon receiving input to carry out transmission/reception of data, control unit 260 (control unit 260-2) of information processing device 200-2 causes first communication unit 211 (first communication unit 211-2) to start near-field wireless communication (signal transmission/reception) (Step S421).

Determination unit 220 (determination unit 220-2) of information processing device 200-2 next checks the state of signal reception of first communication unit 211-2. More specifically, determination unit 220-2 checks the state of signal reception of each of antennas 213A and 213B (antennas 213A-2 and antenna 213B-2) of first communication unit 211-2 (Step S422).

As shown in FIG. 8, information processing device 200-2 is stacked on information processing device 200-1 such that the rear surface side faces information processing device 200-1. As a result, antenna 213B-2 that is provided on the rear-surface side receives a signal from information processing device 200-1. On the other hand, information processing device 200-2 is arranged such that information processing device 200-3 is stacked on the front-surface side of information processing device 200-2. As a result, antenna 213A-2 that is provided on the front-surface side receives a signal from information processing device 200-3.

Determination unit 220-2 next determines the position of information processing device 200-2 on the basis of the states of signal reception of each of antennas 213A-2 and 213B-2 (Step S423). More specifically, because each of antennas 213A-2 and 213B-2 receives a signal, determination unit 220-2 determines that other information processing devices 200 are in proximity on each of the front-surface side and rear-surface side of information processing device 200-2. In other words, determination unit 220-2 determines that other information processing devices 200 are in proximity on each of the upper and lower sides of information processing device 200-2 and reports this determination result to control unit 260-2.

Upon being notified that other information processing devices 200 are in proximity on each of the upper side and lower side of information processing device 200-2, control unit 260-2 determines that information processing device 200-2 is not arranged uppermost among the information processing devices that belong to the information processing device group. As a result, control unit 260-2 determines that information processing device 200-2 is not the master device (Step S424).

Upon determining that information processing device 200-2 is not the master device, control unit 260-2 causes first communication unit 211-2 to transmit the communication ID of information processing device 200-2 to the master device (Step S425).

Upon receiving input to carry out data transmission/reception, control unit 260 (control unit 260-3) of information processing device 200-3 causes first communication unit 211 (first communication unit 211-3) to start near-field wireless communication (signal transmission/reception) (Step S431).

As shown in FIG. 8, information processing device 200-3 is stacked upon information processing device 200-2 such that the rear-surface side faces information processing device 200-2. As a result, antenna 213B-3 that is provided on the rear-surface side receives a signal from information processing device 200-2. On the other hand, another information processing device 200 is not stacked on the front-surface side of information processing device 200-3. As a result, antenna 213A-3 that is provided on the front-surface side does not receive a signal from another information processing device 200.

Determination unit 220 (determination unit 220-3) of information processing device 200-3 checks the state of signal reception of first communication unit 211-3. More specifically, determination unit 220-3 checks the state of signal reception of each of antennas 213A and 213B (antennas 213A-3 and antenna 213B-3) of first communication unit 211-3 (Step S432).

Determination unit 220-3 next determines the position of information processing device 200-3 on the basis of the states of signal reception of each of antennas 213A-3 and 213B-3 (Step S433). More specifically, because antenna 213A-3 does not receive a signal but antenna 213B-3 does receive a signal, determination unit 220-3 determines that another information processing device 200 is not in proximity to the front-surface side of information processing device 200-3 but that another information processing device 200 is in proximity to the rear-surface side.

As shown in FIG. 8, information processing device 200-3 is arranged such that the front-surface side is oriented upward. As a result, determination unit 220-3 determines that another information processing device 200 is not in proximity to above information processing device 200-3 but that another information processing device 200 is in proximity below. Determination unit 220-3 then reports the determination result to control unit 260-3.

Upon being notified that another information processing device 200 is not in proximity to above information processing device 200-3 but that another information processing device 200 is in proximity below, control unit 260-3 determines that information processing device 200-3 is arranged uppermost among the information processing devices belonging to the information processing device group. As a result, control unit 260-3 determines that information processing device 200-3 is the master device (Step S434).

Upon determining that information processing device 200-1 is not the master device, control unit 260-3 causes first communication unit 211-3 to receive the communication IDs that are transmitted in from other information processing devices 200 (Step S435).

Information processing device 200 of the present exemplary embodiment thus includes communication unit 210 that carries out near-field wireless communication with other information processing devices 200; determination unit 220 that determines whether other information processing devices 200 are in proximity on the basis of the communication result of communication unit 210, and control unit 260 that controls the communication operations of communication unit 210.

When data are to be transmitted/received, control unit 260 causes first communication unit 211 of communication unit 210 to carry out near-field wireless communication. Then, if the determination result of determination unit 220 indicates that another information processing device 200 is in proximity, control unit 260 causes communication unit 210 to transition to the reception mode. Alternatively, if the determination result of determination unit 220 indicates that another information processing device 200 is not in proximity, control unit 260 causes communication unit 210 to transition to the transmission mode. Subsequently, if information processing device 200 newly comes into proximity, control unit 260 causes second communication unit 214 of communication unit 210 to carry out data transmission/reception according to the transitioned mode with information processing device 200 that has newly come into proximity.

As a result, by placing a plurality of information processing devices 200 in proximity, communication units 210 of this plurality of information processing devices 200 can be caused to transition to the reception mode. Then, by newly placing information processing device 200 in which communication unit 210 has transitioned to the transmission mode by not being in proximity to another information processing device 200 in proximity to this plurality of information processing devices 200, data are transmitted to the plurality of information processing device 200 from information processing device 200 that newly came into proximity. Accordingly, for example, stacking together a plurality of information processing devices 200 can cause communication units 210 of the plurality of information processing devices 200 to transition to the reception mode. Then, by the simple method of causing information processing device 200 in which communication unit 210 has transitioned to the transmission mode to come into proximity to this plurality of information processing devices 200, data can be transmitted (distributed) all at once to the plurality of information processing devices 200 from information processing device 200 that newly came into proximity

Although explanation has been presented in the present exemplary embodiment using an example in which, after communication unit 210 has been caused to transition to the transmission mode, information processing device 200 starts data transmission after acquiring communication IDs of information processing devices 200 that belong to an information processing device group, but the present invention is not limited to this form.

As a modification, as shown in FIG. 10, another information processing device 200-4 may be arranged in proximity alongside information processing device group 200G to which information processing devices 200-1-200-3 belong. In this case, after information processing device 200-4 has been arranged alongside information processing device group 200G, the data transmission of information processing device 200-4 is started by the input of a slide operation using, for example, movement of user's finger 400 toward information processing device group 200G on touch panel 250 of information processing device 200-4.

In this way, the possibility of transmitting data contrary to the user's intentions can be reduced. Further, determination of the proximity of other information processing devices 200 to any surface of information processing device 200 can be realized by the appropriate disposition of shields and antennas of first communication unit 211, as described in FIG. 4.

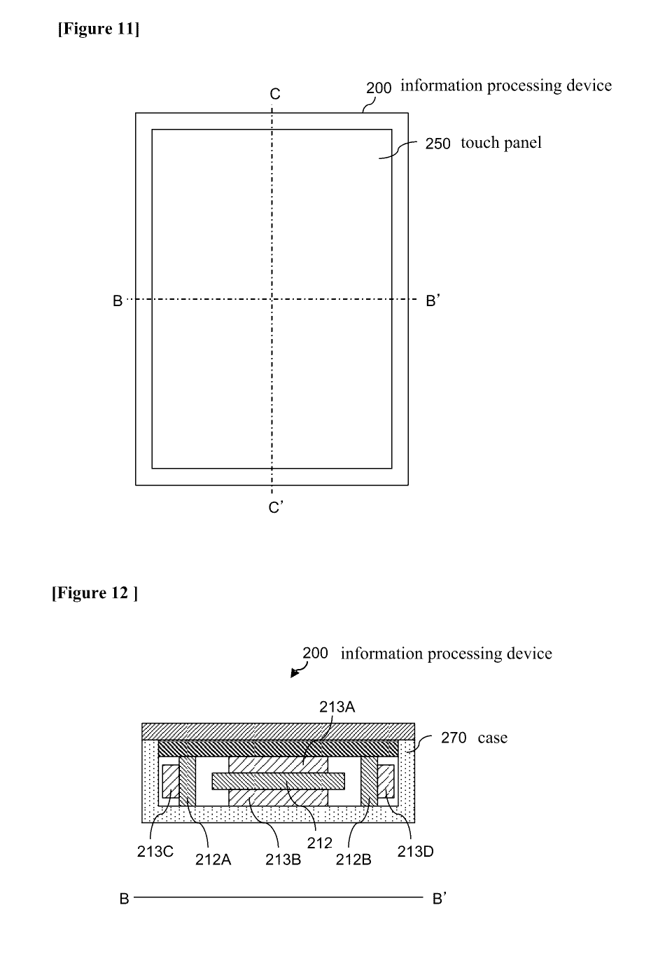

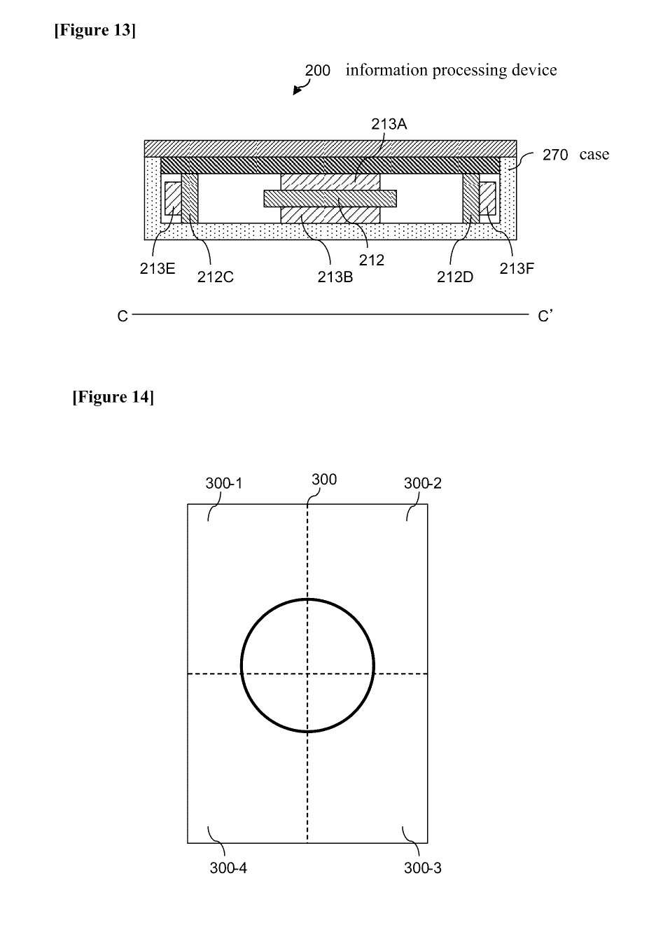

FIG. 11 is a perspective view showing the outer appearance of information processing device 200. In addition, FIG. 12 is a sectional view taken along line B-B′ shown in FIG. 11, and FIG. 13 is a sectional view taken along line C-C′ shown in FIG. 11.

As shown in FIG. 12, shield 212A is provided along the left-side surface of information processing device 200. Antenna 213C is provided between shield 212A and the left-side surface of case 270. Shield 212B is provided along the right-side surface of information processing device 200. Antenna 213D is provided between shield 212B and the right-side surface of case 270.

A signal arriving from the left-surface side of information processing device 200 is received by antenna 213C but is shielded by shield 212A and therefore not received by antenna 213D. On the other hand, a signal arriving from the right-surface side of information processing device 200 is received by antenna 213D but is shielded by shield 212B and therefore not received by antenna 213C.

As a result, determination unit 220 is able to determine the positional relation between its own device and another information processing device 200 (regardless of whether that information processing device 200 is positioned on the left-surface side or positioned on the right-surface side) on the basis of the states of signal reception of antennas 213C and 213D.

In addition, as shown in FIG. 13, shield 212C is provided along the upper-side surface of information processing device 200. Antenna 213E is provided between shield 212C and the upper surface of case 270. Further, shield 212D is provided along the lower-side surface of information processing device 200. Antenna 213F is provided between shield 212D and the lower surface of case 270.

A signal arriving from the upper-surface side of information processing device 200 is received by antenna 213E, but due to the shielding of shield 212C, is not received by antenna 213F. On the other hand, a signal arriving from the lower-surface side of information processing device 200 is received by antenna 213F, but due to the shielding of shield 212D, is not received by antenna 213E.

As a result, determination unit 220 is able to determine the positional relation between its own device and another information processing device 200 (regardless of whether that information processing device 200 is positioned on the upper-surface side or is positioned on the lower-surface side) on the basis of the states of signal reception of antennas 213E and 213F.

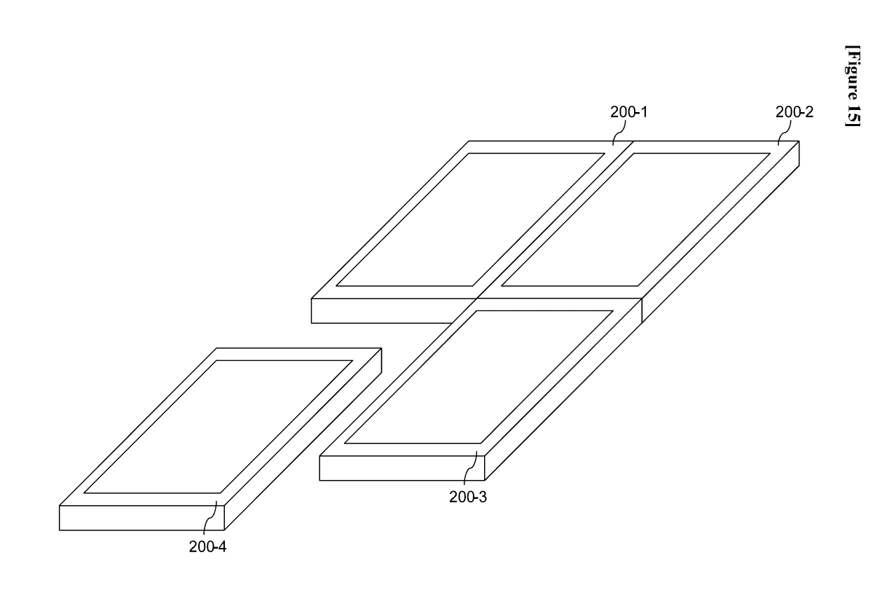

In addition control unit 260 may also control the display of display unit 230 according to the result of determining if another information processing device 200 is located on the left-surface side, or on the right-surface side, or the upper-surface side, or located on the lower-surface side its own device. An example of this type of operation is described with reference to FIGS. 14-16.

In the following explanation, it will be assumed that data indicating image 300 is to be transmitted and received between information processing devices 200, as shown in FIG. 14. It is further assumed hereinbelow that these data are to be transmitted from information processing device 200-4 to information processing devices 200-1-200-3 shown in FIG. 15.

When carrying out the transmission/reception of data, information processing devices 200-1-200-4 each first cause first communication units 211 to start communication (transmission and reception of signals). Information processing devices 200-1-200-3 that are on the receiving side are then arranged in planar form on, for example, a desk, as shown in FIG. 15. In FIG. 15, the right-side surface of information processing device 200-1 contacts the left-side surface of information processing device 200-2. In addition, the lower-side surface of information processing device 200-2 contacts the upper-side surface of information processing device 200-3. In the state shown in FIG. 15, each of information processing devices 200-1-200-3 carry out near-field wireless communication and determine whether other information processing devices 200 are in proximity

As described hereinabove, the right-side surface of information processing device 200-1 contacts the left-side surface of information processing device 200-2. In addition, the lower-side surface of information processing device 200-2 contacts the upper-side surface of information processing device 200-3. As a result, information processing devices 200-1-200-3 each determine that other information processing devices 200 are in proximity.

Upon determining that other information processing devices 200 are in proximity, each of information processing devices 200-1-200-3 causes communication unit 210 to transition to the reception mode.

On the other hand, as shown in FIG. 15, when transmission/reception of data is to be carried out, information processing device 200-4 that is on the data transmitting side is kept in a state separated from other information processing devices 200-1-200-3.

In the state shown in FIG. 15, information processing device 200-4 determines whether other information processing devices 200 are in proximity Information processing device 200-4, that is separated from the other information processing devices 200-1-200-3, is unable to transmit or receive signals using near-field wireless communication with other information processing devices 200. If the state in which information processing device 200-4 is unable to use near-field wireless communication to transmit or receive signals with other information processing devices 200 continues for at least a predetermined time interval, information processing device 200-4 determines that other information processing devices 200 are not in proximity.

Upon determining that other information processing devices 200 are not in proximity, information processing device 200-4 causes communication unit 210 to transition to the transmission mode.

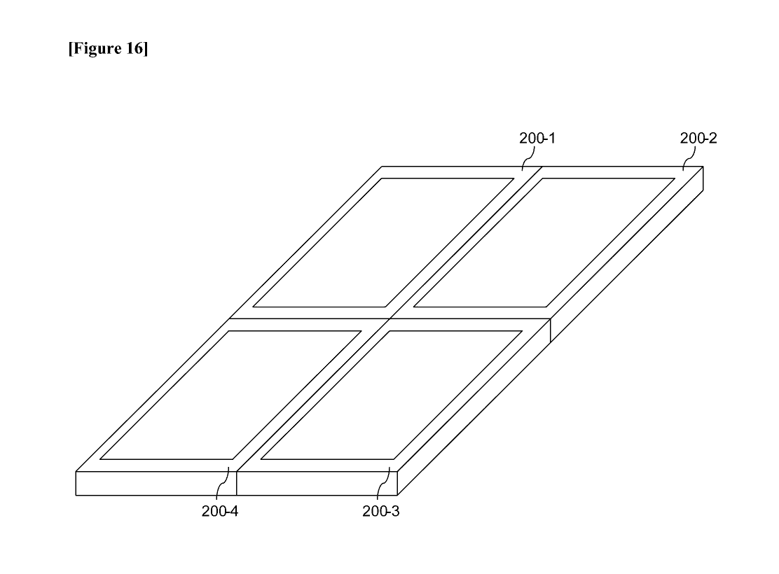

After information processing device 200-4 has caused communication unit 210 to transition to the transmission mode and information processing devices 200-1-200-3 have caused communication units 210 to transition to the reception mode, information processing device 200-4 is placed in proximity to information processing devices 200-1-200-3 as shown in FIG. 16.

In FIG. 16, information processing device 200-4 is arranged such that its upper-side surface of contacts the lower-side surface of information processing device 200-1 and its right-side surface contacts the left-side surface of information processing device 200-3.

In the state shown in FIG. 16, each of information processing devices 200-1-200-4 determines whether other information processing devices 200 have newly come into proximity. As described hereinabove, information processing device 200-4 has newly come into proximity to information processing devices 200-1-200-3, and each of information processing devices 200-1-200-4 therefore determines that another information processing device 200 has newly come into proximity.

Upon determining that another information processing device 200 has newly come into proximity, each of information processing devices 200-1-200-4 determines the positional relation of its own device and other information processing devices 200 on the basis of the states of signal reception of antennas 213C-213F.

As shown in FIG. 16, information processing device 200-1 is arranged such that its right-side surface contacts information processing device 200-2 and its lower-side surface contacts information processing device 200-4. As a result, information processing device 200-1 determines that the right-side surface and lower-side surface of its own device are in proximity to other information processing devices 200, i.e., that its own device is located on the upper left corner.

In addition, information processing device 200-2 is arranged such that its left-side surface contacts information processing device 200-1 and its lower-side surface contacts information processing device 200-3. As a result, information processing device 200-2 determines that the left-side surface and lower-side surface of its own device are in proximity to other information processing devices 200, i.e., that its own device is located on the upper right corner.

Further, information processing device 200-3 is arranged such that its left-side surface contacts information processing device 200-4 and its upper-side surface contacts information processing device 200-2. As a result, information processing device 200-3 determines that other information processing devices 200 are in proximity to the left-side surface and upper-side surface of its own device, i.e., that its own device is located on the lower right corner.

Finally, information processing device 200-4 is arranged such that its right-side surface contacts information processing device 200-3 and its upper-side surface contacts information processing device 200-1. As a result, information processing device 200-4 determines that the right-side surface and upper-side surface of its own device are in proximity to other information processing devices 200, i.e., that its own device is located on the lower left corner.

After completion of data transmission/reception, each of information processing devices 200-1-200-4 causes an image indicated by the data to be displayed on display unit 230. Each of information processing devices 200-1-200-4 here displays an image that accords with the location of its own device.

More specifically, information processing device 200-1 determines that its own device is located on the upper left corner, and information processing device 200-1 therefore displays on display unit 230, from among divided images 300-1-300-4 that are obtained by evenly dividing each of the vertical and horizontal directions of image 300 that are shown by the data that are the object of transmission/reception, divided image 300-1 of the upper left corner.

Further, information processing device 200-2 determines that its own device is located on the upper right corner, and as a result, information processing device 200-2 displays on display unit 230 divided image 300-2 of the upper right corner of divided images 300-1-300-4.

Information processing device 200-3 determines that its own device is located on the lower right corner, and as a result, information processing device 200-3 displays, from among divided images 300-1-300-4, divided image 300-3 of the lower right corner on display unit 230.

Finally, information processing device 200-4 determines that its own device is located on the lower left corner, and as a result, information processing device 200-4 displays, from among divided images 300-1-300-4, divided image 300-4 of the lower left corner on display unit 230. By thus controlling the display of display units 230 of each of information processing devices 200 according to the positional relation of the plurality of information processing devices 200 that are in proximity, display units 230 of the plurality of information processing devices 200 can be used as if the display units were a single display unit, thereby enabling a screen enlargement.

Although explanation in the present exemplary embodiment used an example in which second communication unit 214 carried out communication with other information processing devices 200 in accordance with a wireless LAN standard such as Wi-Fi, the present invention is not limited to this form. For example, second communication unit 214 may also have the capability of carrying out communication by way of a mobile network such as 3G (Third Generation Mobile Communication Network) or LTE (Long Term Evolution).

In this case, second communication unit 214 transmits, to a server on the mobile network, communication IDs acquired from information processing devices that belong to the information processing device group and the data that are the transmission object. The server transmits the data that were received to information processing devices 200 that are indicated by the communication IDs that were received.

Although the invention of the present application has been described with reference to exemplary embodiments, the invention of the present application is not limited to the above-described exemplary embodiments. The configuration and details of the invention of the present application are open to various modifications within the scope of the invention of the present application that will be clear to one of ordinary skill in the art.

This application claims the benefits of priority based on Japanese Patent Application No. 2014-054545 for which application was submitted on Mar. 18, 2014 and incorporates by citation all of the disclosures of that application.

### EXPLANATION OF REFERENCE NUMBERS

100, 200 information processing device
200G information processing device group
110, 210 communication unit
120, 220 determination unit
130, 260 control unit
211 first communication unit
212, 212A, 212B 212C, 212D shield
213A, 213B, 213C, 213D, 213E, 23F antenna
214 second communication unit
230 display unit
240 input unit
250 touch panel

1. An information processing device comprising:
a communication unit that carries out near-field wireless communication with other information processing devices;
a determination unit that, on the basis of the results of communication of said communication unit, determines whether another information processing device is in proximity; and
a control unit that, on the basis of the determination result of said determination unit, controls the communication operation of said communication unit;
wherein:
said control unit causes said communication unit to transition to a reception mode when the result of determination of said determination unit indicates that another information processing device has come into proximity, and causes said communication unit to transition to a transmission mode when the result of determination of said determination unit indicates that another information processing device has not come into proximity.

2. The information processing device as set forth in claim 1, wherein:
when an information processing device newly comes into proximity after transition of mode, said communication unit carries out transmission/reception of data according to the transitioned mode with said information processing device that has come into proximity.

3. The information processing device as set forth in claim 2, wherein:
said communication unit includes:
a first communication unit that carries out near-field wireless communication; and
a second communication unit having a faster communication speed than said first communication unit;
wherein:
said second communication unit transmits/receives data.

4. The information processing device as set forth in claim 2, wherein:
when said communication unit transitions to said reception mode, said first communication unit transmits identification information that is necessary for transmission/reception of data by means of said second communication unit to said information processing device that has newly come into proximity.

5. The information processing device as set forth in claim 4, wherein:
when another information processing device comes into proximity, said determination unit determines the positional relation between its own device and the other information processing device;
on the basis of the positional relation that was determined by said determination unit, said control unit determines whether its own device is, from among information processing devices that belong to an information processing device group that is composed of a plurality of information processing devices that are in proximity, a master device that is arranged at a predetermined position; and
upon determination that its own device is said master device, said first communication unit receives said identification information of each information processing device that belongs to said information processing device group and transmits identification information that was received together with identification information of its own device to said information processing device that has newly come into proximity.

6. The information processing device as set forth in claim 1, further comprising a display unit; wherein:
when an information processing device newly comes into proximity after transition of the mode of said communication unit, said determination unit determines the positional relation between its own device and the other information processing device; and
on the basis of the positional relation that was determined by said determination unit after completion of transmission/reception of said data, said control unit controls display of said data on said display unit.

7. The information processing device as set forth in claim 1; any one of claims 1 to 6; further comprising an input unit that detects operation input realized by contact with or proximity to a material object; wherein:
when predetermined operation input is carried out to said input unit after said communication unit has transitioned to a transmission mode and an information processing device has newly come into proximity, said communication unit transmits said data.

8. A control method of an information processing device wherein:
said information processing device is provided with a communication unit that carries out near-field wireless communication with other information processing devices,
whether another information processing device has come into proximity is determined on the basis of the result of communication of said communication unit; and
when said determination result indicates that another information processing device has come into proximity, said communication unit is caused to transition to a reception mode, and when said determination result indicates that another information processing device has not come into proximity, said communication unit is caused to transition to a transmission mode.

9. The control method of an information processing device as set forth in claim 8, wherein:
when an information processing device newly comes into proximity after transition of mode, said communication unit carries out transmission/reception of data in accordance with the transitioned mode with said information processing device that has newly come into proximity.

10. The control method as set forth in claim 9, wherein:
said communication unit is made up by a first communication unit that carries out near-field wireless communication and a second communication unit having communication speed that is faster than said first communication unit; and
said second communication unit transmits/receives data.

11. The control method as set forth in claim 10, wherein:
when said communication unit transitions to said reception mode, said first communication unit transmits identification information that is necessary for transmission/reception of data by said second communication unit to said information processing device that has newly come into proximity.

12. The control method as set forth in claim 11, wherein:
when another information processing device is determined to have come into proximity, the positional relation between the other information processing device and its own device is determined;
whether its own device is, of information processing devices that belong to an information processing device group that is composed of a plurality of information processing devices that are in proximity, a master device that is arranged at a predetermined position is determined on the basis of said positional relation that was determined;
when its own device is determined to be said master device, said first communication unit receives said identification information of each information processing device that belongs to said information processing device group and transmits the identification information that was received together with identification information of its own device to said information processing device that has newly come into proximity.

13. The control method as set forth in claim 8, wherein:
a display unit is further provided in said information processing device;
when an information processing device newly comes into proximity after transition of the mode of said communication unit, the positional relation between its own device and the other information processing device is determined; and
after completion of said data transmission/reception, the display of said data on said display unit is controlled on the basis of the positional relation that was determined by said determination unit.

14. The control method as set forth in claim 1, wherein:
an input unit that detects operation input realized by the contact or proximity of a material object is further provided in said information processing device; and
when predetermined operation input is carried out to said input unit after said communication unit has transitioned to said transmission mode and an information processing device has newly come into proximity, said communication unit transmits said data.
